(19) United States
(12) Patent Application Publication
(10) Pub. No.: US 2012/0066041 A1
(43) Pub. Date: Mar. 15, 2012

(54) SYSTEMS AND METHODS FOR VIRTUAL TRANSFERRING OF GIFTS

(76) Inventor: Jeffrey W. Mankoff, Dallas, TX (US)

(21) Appl. No.: 13/231,946

(22) Filed: Sep. 13, 2011

Related U.S. Application Data
(60) Provisional application No. 61/382,464, filed on Sep. 13, 2010.

(51) Int. Cl. G06Q 20/12; G06Q 30/02; G06Q 30/06

(52) U.S. Cl. 705/14.17; 705/26.1

(57) ABSTRACT

Disclosed are methods and systems for offering virtual gifts to consumers. In some embodiments, the method includes offering a virtual gift to a purchaser. Upon electronic acceptance of the virtual gift by the purchaser, establishing or maintaining an association of the accepted virtual gift with at least one form of payment associated with the purchaser. Upon a purchaser's request to transfer the virtual gift to a recipient and electronic acceptance of the virtual gift by the recipient, establishing or maintaining an association of the accepted virtual gift with at least one form of payment associated with the recipient. Upon purchase of the subject matter of the accepted virtual gift with the form of payment associated with the recipient, electronically receiving a redemption of the accepted virtual gift.

### RELATED APPLICATIONS

This application claims priority to U.S. Prov. Pat. App. No. 61/382,464, entitled, “Systems and Methods for Virtual Transferring of Gifts,” filed Sep. 13, 2010, which is hereby incorporated by reference into this application.

### TECHNICAL FIELD

The principles disclosed herein relate generally to virtual gifts, and more particularly to purchasing and the virtual transferring of a gift card or gift certificate, without issuing a new magnetic stripe card or paper certificate, or other tangible gift voucher or credit, which can be arranged to be given as a gift to a designated recipient, yet returned to the purchaser if not accepted or redeemed by the recipient.

### BACKGROUND

On many occasions, consumers may find it desirable to mail a gift to another person who is geographically distant or in the same city. In these and other cases, it is often undesirable to give away or send cash. If lost or stolen, cash is practically unrecoverable. Gift certificates are also undesirable because they require the recipient to purchase from the merchant that issued the gift certificate, and mail it or hand-deliver it. Gift cards are also undesirable, in that the purchaser must typically go to a specific store, find a card, and pay for it. Then this card still needs to be delivered to the recipient. Gift cards can also be purchased online.

But then the recipient needs to input the physical address of the recipient, which may be unavailable to the purchaser, and there is still the expense of the creation and delivery of the gift card to the recipient. The cost of creation of the physical gift card is usually absorbed by the merchant. The delivery cost of a gift card purchased online is usually paid for by the purchaser. Gift cards are inconvenient for the recipient as well, in that consumers' wallets are overstuffed with unused gift cards and certificates. The recipient must remember to bring the gift card with him to redeem the gift card. Also, often times the gift card has an unknown balance on it. These cards can also be lost and/or expire. Further, there are expiration and escheat issues that create a liability for the merchants. These and other drawbacks exist to the aforementioned, as well as other, gift alternatives.

Today we are seeing virtual gifts on social media sites. These virtual gifts are not real, but pretend gifts. For example, on a social network, Sam may give George a virtual gift of a pretend beer. This virtual gift will show up on George's newsfeed. Some of the social networks are actually charging for these virtual gifts. The present inventor believes that there is a market for a real and valuable gift to be delivered virtually, but can actually be redeemed easily and conveniently at a brick-and-mortar store.

### BRIEF SUMMARY

Disclosed are methods and systems for offering virtual gifts to consumers. In some embodiments, the method includes offering a virtual gift to a purchaser. Upon electronic acceptance of the virtual gift by the purchaser, establishing or maintaining an association of the accepted virtual gift with at least one form of payment associated with the purchaser. Upon a purchaser's request to transfer the virtual gift to a recipient and electronic acceptance of the virtual gift by the recipient, establishing or maintaining an association of the accepted virtual gift with at least one form of payment associated with the recipient. Upon purchase of the subject matter of the accepted virtual gift with the form of payment associated with the recipient, electronically receiving a redemption of the accepted virtual gift.

The present disclosure provides several important technical advantages that will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

FIG. 1 is a block diagram for a virtual gift system;

FIG. 2 is an exemplary process flow diagram for purchase, transfer, and redemption of virtual gifts;

FIG. 3 is an provides an exemplary screenshot of an offer of a virtual gift;

FIG. 4A is an exemplary screen shot of a purchaser accepting a virtual gift;

FIG. 4B is an exemplary screen shot of an acknowledgement message sent to a purchaser upon the acceptance of a virtual gift;

FIG. 5A is an exemplary screen shot of a purchaser transferring a virtual gift to a recipient;

FIG. 5B is an exemplary screen shot of an acknowledgement message sent to a purchaser upon the transfer of a virtual gift to a recipient;

FIG. 5C is an exemplary screen shot of the offer of a virtual gift to a recipient; and

FIG. 6 is a block diagram for a recipient to use a form of payment to redeem a virtual gift.

All of these drawings are illustrations of certain embodiments. The scope of the claims is not limited to the specific embodiments illustrated in the drawings and described below.

### DETAILED DESCRIPTION OF THE EMBODIMENTS

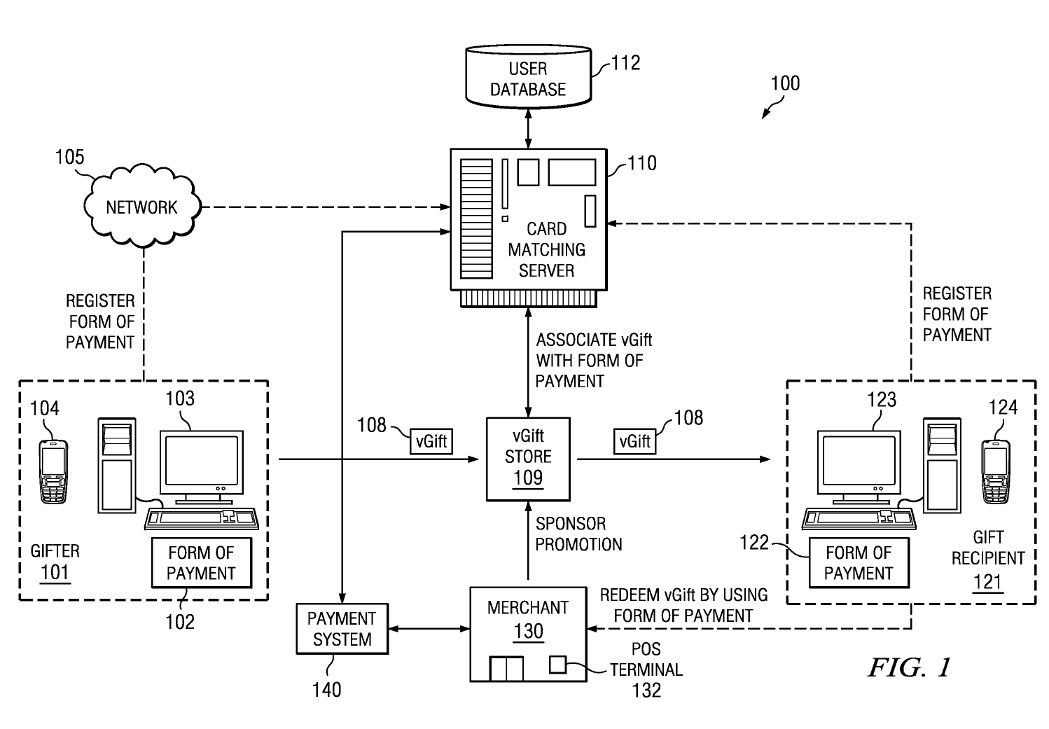

FIG. 1 is a block diagram for a virtual gift system 100 in which consumers 101, 121 are each provided with a database 112 that can be associated with the consumers' form of payment 102, 122, such as credit card, debit card, electronic fund transfer account or other payment means. Virtual gifts 108 may be offered to gifters/purchasers 101 via a virtual gift store 109 or other source to consumers through email, through websites on the Internet, or through other networks 105. Gifter 101 may purchase and accept virtual gift 108, and associate a form of payment 102 with virtual gift 108 in database 112. Gifter 101 may transfer or offer virtual gift 108 to a recipient 121. Recipient 121 may accept virtual gift 108 and associate a form of payment 122 with virtual gift 108 in database 112. Recipient 121 may use form of payment 122 with a point of sale terminal 132 at a merchant 130 to complete a purchase via a payment system 140. Payment system 140 may determine if the form of payment is associated with virtual gift 108, and apply a discount associated with virtual gift 108 to the purchase goods using a form of payment 122, in which virtual gift 108 may be automatically redeemed by using the form of payment at a brick and mortar merchant 130. System 100 provides an easy way for purchaser 101 to deliver virtual gift 108 to recipient 121 to redeem virtual gift 108 by using a form of payment 122 at a point of sale terminal 132 at a merchant 130. Thus, virtual gift 108 may be emailed or electronically delivered to the recipient 122, which avoids the hassle, delay and cost of delivery of traditional gift cards. Consumers 101, 121 can manage virtual gifts 108 in database 112 through the consumers' personal computers 103, 123, Personal Digital Assistants (“PDAs”) 104, 124, or other electronic devices.

Consumers (e.g., gifter 101, and recipient 121) may use any type of client device 103, 104, 123, 124 in use with system 100. For example, client devices 103, 104, 123, 124 may include, but are not limited to, mobile devices; cell phones; laptop computers; desktop computers; end user devices; video monitors; cameras; PDAs; or any other communication hardware, software, and/or encoded logic that supports the communication of web pages, images, videos, text or other suitable forms of data. Additionally, in particular embodiments, client devices may include one or more browsers and/or one or more processors operable to execute computer logic and/or software encoded on tangible media that perform the described functionality. Client device 103, 104, 123, 124 may include one or more input devices such as a keyboard, trackball, mouse, and/or one or more Graphical User Interfaces (GUIs) through which user 32 may interact with the applications running on client. Client device 103, 104, 123, 124 may include any appropriate combination of hardware, software, and/or encoded logic suitable to perform the described functionality. Client device 103, 104, 123, 124 may include memory. Client device 103, 104, 123, 124 may be communicatively coupled elements in system 100 via network 5. System 100 may comprise any appropriate number and type of client devices 103, 104, 123, 124.

Form of payment 102, 122 may be anything capable of making a purchase, including, but not limited to, credit cards, debit cards, electronic payment accounts, consumer billing systems, cell-phone-based electronic payment systems, and PDA-based electronic communication systems. For example, a PDA may be capable of transmitting near field communication electronic signals associated with a form of payment 120 to a point of sale device at merchant 130 to complete a purchase.

Network 105 may represent any form of communication network supporting circuit-switched, packet-based, and/or any other suitable type of communications. Network 105 may additionally include any other components of system 100 capable of transmitting and/or receiving information over a communication network, including clients 103, 104, 123, 124, virtual gift store 109, card matching server 110, user database 112, merchant 130 and/or payment system 140. Although shown in FIG. 1 as a single element, network 105 may represent one or more separate networks (including all or parts of various different networks) that are separated and serve different respective elements illustrated in FIG. 1. Network 105 may include routers, hubs, switches, firewalls, content switches, gateways, call controllers, and/or any other suitable components in any suitable form or arrangement. Network 105 may include, in whole or in part, one or more secured and/or encrypted Virtual Private Networks (VPNs) operable to couple one or more network elements together by operating or communicating over elements of a public or external communication network. In general, network 105 may comprise any combination of public or private communication equipment such as elements of the public switched telephone network (PSTN), a global computer network such as the Internet, a local area network (LAN), a wide area network (WAN), or other appropriate communication equipment.

Virtual gifts 108 are any type of paperless or cardless credit or coupon or discount that may be transferrable over network 105 to recipients 121. System 100 makes it easy for a gift purchaser 101 to buy a “gift credit” or virtual gift 108 for a particular merchant or item, and then email or otherwise electronically deliver the virtual gift 108 to recipient 121. One cannot email or electronically deliver a physical gift card. With the present disclosure, however, a virtual gift or a “vGift” can be emailed or otherwise transferred or delivered electronically to an intended recipient 121. Thus, system 100 provides for a paperless offer where recipient 121 can accept a virtual gift linked to recipient's form of payment 122, such that recipient 121 does not need to carry any additional cards or paper in recipient's 121 wallet or purse. In some embodiments, merchant 130 may determine the details of the virtual gifts 108.

A virtual gift store 109 may offer one or more virtual gifts to consumers 101, 121. Virtual gift store 109 may also process acceptances, purchases, transfers, redemptions, and management of virtual gifts 108. For example, purchaser 101 can go online to the a web site associated with virtual gift store 109, locate a particular virtual gift 108 for a particular merchant or item, select the virtual gift 108, view the shopping cart, purchase the virtual gift 108, and then select a recipient to receive the offer for the purchased virtual gift 108. System 100 or virtual gift store 109 may email or electronically deliver the virtual gift 108 or an offer of the virtual gift 108 to the recipient 121. In some embodiments, when the recipient 121 opens the email, he can click a link, wherein recipient 121 is taken to a web site associated with virtual gift store 109 in which recipient 121 can register, if recipient 121 has not already done so. While registering, recipient 121 can provide a form of payment 102 (e.g., credit or debit card number), or in other embodiments, any other payment method or vehicle useable by the recipient 121 to purchase goods or services. In embodiments, a recipient 121 links or associates virtual gift 108 to a form of payment 102, 122. In some embodiments, virtual gifts 108 may be offered or transferred via emails, banner ads, web page, social network sites, interactive television, cell phones, satellite phones, land-based phones, PDA-based wireless devices, electronic kiosks, etc.

Within or external to the virtual gift store 109 is provided a card matching server 110, which may be used to link virtual gifts 108 stored and associated with consumers' databases 112 with payment transactions that are being cleared through payment system 140. Through these linkages, proper credit can be applied in those instances in which consumers have redeemable virtual gifts 108 stored in their associated databases 112 for products they have purchased. For example, every time recipient 121 uses a form of payment 122 at a point of sale terminal 132, payment system 140 may communicate with card matching server 110 or user database 112 to determine if a virtual gift 108 is associated with the form of payment 122 and/or the merchant 130 and/or the goods or services purchased.

User database 112 may store information relevant to virtual gifts 108. For example, user database 112 may include an entry linking a consumer's name, one or more addresses for consumer, one or more forms of payment, one or more virtual gifts, one or more expiration dates associated with the one or more virtual gifts, etc. In some embodiments, user database 112 may link virtual gift 108 to both the purchaser 101 and the recipient 121.

To redeem virtual gifts 108, recipients 121 (and even purchasers 101 in some instances) may visit the merchants 130—traditional (e.g., physical brick and mortar site having a physical address) or online (e.g., virtual location having an electronic address)—connected to the network as shown in FIG. 1. In this embodiment, the recipient 121 (or purchaser 101) can redeem virtual gifts 108 by the use of a form of payment to purchase a service or good provided by merchant 130. The online or traditional merchant 130 may communicate with a payment system 140 (e.g., the credit card issuing bank) whenever the consumers' methods of payment 102, 122 are presented to the merchants 130. At a traditional merchant 130, for instance, the forms of payment 102, 122 may be run at a Point-Of-Sale (“POS”) terminal 132. The POS terminals 132 may communicate through a secure connection to a payment system 140 (e.g., a credit card mainframe). This secure connection may be through a security interface unit provided at both ends of the connection between the merchant 130 and payment system 140. The connection between the merchant 130 and the payment system 140 could be through the Internet or through traditional point-to-point communications, such as leased or dial-up telecommunications data lines. For example, recipient 121 may pay with a form of payment 122 (which has been previously registered with the virtual gift store 109) the way recipient 121 normally does. However in accordance with the disclosed principles, recipient 121 may receives a discount at the point of sale by merely purchasing goods or services qualifying under the virtual gift 108 associated with the form of payment 122 used.

Payment system 140 may be any type of hardware and/or software that is capable of processing the payments associated with the form of payment used by consumers 101, 121. For example, payment system may represent a credit card mainframe, credit card interface servers, and/or a debit card or credit card issuing financial institution, etc. Although the functional block represented by payment system 140 is shown as a block at a single site, this broad function may be more specifically implemented using at least two separate sites and/or computer systems. One site as an example may be the acquiring or merchant servicing bank site, which may interface with merchant 130 receiving Authorization Requests and returning Approval Codes through a security interface. The second site in the example may be the credit card issuing bank, which may communicate with the acquiring bank computer system to gather the transaction data and communicate with credit card interface servers in order to determine when to apply appropriate discounts to the consumers' credit card statement. Both the first and the second site may be functionally encompassed within payment system 140.

For example, approval and clearing operation for a form of payment 102, 122 with payment system 140 may occur as follows. Consumer 101, 121 may bring his associated credit card to the merchant 130 after the consumer 101, 121 has accepted and stored a virtual gift 108 in user database 112. The consumer 101, 121 may then give his card to the merchant employee, who may swipe the card through a credit card reader associated with the POS Terminal 132 as is normally done in a credit card transaction. Merchant 130 may then communicate with the credit card computer system 140 in order to seek an authorization code for the transaction from the credit card computer system 140. The payment system 140 may then communicate with card matching server 110, user database 122, and/or virtual gift store 109 to determine whether the consumer 101, 121 is entitled to a discount according to that consumer's purchases at the merchant 130. Payment system 140 may also gather the necessary data offline, e.g., separate from the regular credit card authorization process. The interface for this virtual gift 108 clearing process may alternatively be an entirely parallel network between the merchant 130 and the payment system 140.

The discount associated with the virtual gift 108 can be applied in a number of ways. One way is to transmit the discount back to the POS Terminal 132 through the security interfaces as a part of the normal credit card approval process.

A second way may be to apply the discount to the monthly statement of the consumer 101, 122 in the payment system 140. And a third way may be for the discounts to be accumulated and reimbursed to the consumer 101, 122 through the issuance of a check or other form of payment from either the payment system 140, merchant 130, or virtual gift store 109.

Many possible virtual gift 108 variations, as well as variation in virtual gift 108 delivery mechanisms, are possible. For example, the virtual gift offers can be made by a virtual gift store 109 or merchant 130 and delivered to the gifters 101 through mobiles phones, wireless PDAs, email, web sites, social networking sites, interactive televisions, two-way pagers or other electronic communication systems. In another example, the virtual gift offers can be made by gifter 101 who has purchased virtual gift 108 and delivered to recipients 121 through mobiles phones, wireless PDAs, email, web sites, social networking sites, interactive televisions, two-way pagers or other electronic communication systems. It is further possible through the consumers' electronic communications systems to detect where the consumers 101, 121 are located and thereby to target offers to consumers 101, 121 based on their location. For example, when connecting through wireless connections, the particular wireless tower or access point through which the consumer 101, 121 is connecting to network 105 can be detected, whereby geographic-specific offers can be made to a plurality of consumers 101, 121. As further examples, a particular consumer's 101 location can be detected by use of: satellite-based positioning systems; triangulation from land-based radio transmissions; detection of which transmission tower is communicating with a consumer's cell-based electronic device; and detection of a communication hub communicating with a consumer's local-area-network-based electronic device.

The direct association of virtual gift or virtual gift offers with the consumers' payment systems 140 and forms of payment 102, 122 in user database 112 can make the targeted offers more flexible. In a specific example, an offer can be made to a consumer 101 for a merchant 130 that is close to the consumer 101 based on the consumers' location. Such offers could, for example, be advantageously delivered to consumers' portable devices, such as cell phones or wireless PDAs, based on the consumers' detected locations. Rather than delivering an offer to be displayed on such portable devices for display to a merchant as a means of redemption, the present embodiments allow consumers 101, 121 to electronically accept the virtual gift offers and have those offers be associated with the consumers' credit cards or other payment systems. As with paper coupons, this electronic acceptance and association with the consumers' payment system also mitigates against possible fraudulent attempts to redeem invalid offers, such as by displaying a contrived or unauthorized offer screen to the merchants 130. The described embodiments further may negate the need for the merchant to install additional equipment, such as might be used if an accepted virtual gift 108 were to be electronically “beamed” from the consumers' portable devices to the merchant POS terminal 132 or other equipment at the merchant POS.

Because consumer 101, 121 has been freed from the necessity of printing out the virtual gift 108 or otherwise downloading it to a local device, the consumer 101, 121 can simply accept the virtual gift 108 and thereby associate it with the consumer's credit card 122 or other payment system 140. Also, because of the immediacy of storing virtual gifts 108 on the consumer's form of payment 102, 122 or on payment system 140, as well as the trackability of where the virtual gift 108 has been clicked or accepted, it is readily possible to make the offer time-adaptable. For example, the consumer 101, 121 might be in the vicinity of Retailer XYZ 130, and the consumer accordingly might be given a virtual gift 108 offer for 25% off of purchases at that retailer made within 3 hours (or, as another example, the same day). The virtual gift 108 offer might decrease 5% in value during the next time period (e.g., between 3 hours and 12 hours or during the next day), and decrease another 5% in the next period, and so on.

When the capability of locating a consumer is coupled with the offering of time-triggered, date-triggers, and time-sensitive offers, certain synergies emerge. For example, a consumer 101, 121 might be “out on the town” on a Saturday night with their cell phone. Given the time and the consumer's location, consumer 101, 121 might receive a real-time virtual gift offer on their cell phone (or PDA or similar device) for a close-by eatery or nightclub 130. The offer might be good only for the evening, or it might be worth less at a later time or date. By accepting the offer, the consumer 103 may accordingly associate the offer with their form of payment 102, 122, and the virtual gift 108 can then be readily redeemed at the local area, while the consumer 101, 121 is still in that area. In another example, gifter 101 may be notified by virtual gift store of a special event (e.g., a birthday) associated with recipient 121. Virtual gift store 109 may have access to this information via social networking sites or data entered by its users. Accordingly, gifter 101 can receive timely offers to purchase virtual gifts 108 for recipients 121. By this approach, not only is the delivery, acceptance, and redemption of the virtual gift 108 streamlined relative to traditional gift delivery method, but it also more effectively targets the market for the paperless coupon offer relative to more traditional approaches.

In another example of a time-sensitive offer, system 100 may allow apply a refund or credit to purchaser 101 of virtual gift 108 in the event that virtual gift 108 is not accepted or redeemed by recipient 121 within a certain period of time (e.g., one year from the date of purchase). State and federal laws may prohibit including expiration dates on gift cards and gift certificates, which can create accounting and escheat problems for merchants 130. One reason that these laws exist is because gift certificates and magnetic stripe gift cards are not traceable if not used. Gift cards are typically meant to be delivered as gifts, and are sold anonymously at grocery or drug stores. Even if a gift card is purchased online directly from merchant 130, it is unlikely that merchant 130 knows who is the final recipient of the card at the time of purchase. And even if the recipient of the gift card purchased online is known, gift cards are transferable. Re-gifting gift cards is rampant and simply adds to the tracking problem. System 100 also eliminates many of the expiration date issues for gift cards. For example, virtual gift 108 might have a one year refund date. When the purchaser 101 offers or transfers the virtual gift 108 to recipient 121, the recipient 121 will have a certain time to accept the virtual gift 108 and register information associated with the form of payment, if recipient has not already done so. If recipient 121 does not accept or redeem virtual gift 108 within the time period, then purchaser 101 of virtual gift 108 may not be charged or may be offered a refund or credit. This is similar to not charging for the purchase of an item until that item has been delivered. Once recipient 121 registers form of payment 122 and accepts virtual gift 108, purchaser 101 may be charged at that time. In another example, purchaser 101 may be charged upon purchase of virtual gift 108, but then the form of payment 102 or account is credited back if virtual gift 108 is not accepted or redeemed within the time period.

Once accepted, the registered recipient 121 then may have a predetermined time period, such as one year to redeem that virtual gift 108. In some embodiments, the registered recipient 121 (or perhaps even the purchaser 101) may be given the option to extend the time period for redemption, and perhaps even for a fee or simply a reduction in the amount of virtual gift 108. The benefits of system 100 may allow system 100 to send reminders to recipient 121 to redeem virtual gift 108 prior to the refund date or expiration date. If recipient 121 still has not redeemed virtual gift 108 within the time required, a credit could be returned to purchaser 101 of virtual gift 108. This would not be possible with a standard analog or tangible gift certificate or magnetic stripe gift card, because the analog and tangible gift system does not know who received a gift, and whether or not the gift was redeemed.

A further object of this disclosure is to provide a means to eliminate the loss of gift cards by using virtual gifts 108. Because there is no gift card involved, there is no gift card that can be lost. Should the recipient 121 (or purchaser 101) lose the form of payment 102, 122 (e.g., their credit card) that is linked to virtual gift 108, recipient 121 (or purchaser 101) need only go online to the web site of virtual gift store 109 and register a new form of payment 102, 122, or perhaps the same form of payment 102, 122 with a new credit card number or expiration date.

A further object of this disclosure is to notify purchaser 101 that recipient 121 has received and accepted virtual gift 108 and registered the recipient's 121 existing form of payment 122 to enable redemption of virtual gift 108. A further object of this disclosure is to provide the recipient 121 electronic reminders to use virtual gift 108 so that virtual gift 108 may be timely redeemed. A further object of this disclosure is to notify purchaser 101 whether recipient 121 redeems virtual gift 108 or does not redeem virtual gift 108 within a certain time.

Another object of the present disclosure is to provide a method for converting a consumer 101, 121 using virtual gifts 108 into a loyalty member of the merchant 130 or virtual gift store 109. Because one or more forms of payment 102, 122 of consumer 101, 121 is already stored on system 100, these forms of payment 102, 122 (or account number for other type of payment vehicle) can be added to the a reward system for merchant 130 or virtual gift store 109, and then be used to track every time the consumer 101, 121, and now reward member, shops at virtual gift store 109 or merchant 130 with the registered form of payment associated with virtual gifts 108. As such, points can be earned for virtual gift store 109 or for that particular merchant 130 on behalf of consumer 101, 121. Such an approach differs from a conventional loyalty system because it provides a means to conveniently migrate a purchaser 101 or recipient 121 of virtual gift 108 into a reward/loyalty member of virtual gift store 109 or a particular merchant 130. Thus, rewards system may provide incentives to continually use the form of payment 102, 122 at virtual gift store 109 and/or one or more merchant sites 130.

A further object of this disclosure is to provide an easy, simple viral system to deliver virtual gifts 108. By making it easy to deliver virtual gifts 108 via e-mail or through a social media or networking site, a gift giver 101 can easily go to his friends list and select friends (i.e., recipients 121) to deliver virtual gifts 108. When virtual gift 108 is delivered to a friend 121, this will result in a new member to the system 100. As one example of the system becoming viral, system 100 may send a notification to a web page (of perhaps a social networking site) associated with an account of the purchaser 101 and/or recipient 121 upon the successful transfer or redemption of the virtual gift 108.

A further object of this disclosure is to provide convenience for recipients 121 of virtual gifts 108. For recipients 121 of virtual gifts 108 who already are members of the system 100, they need not register every time. A member of the system 100 will have his form of payment 102, 122 data already in the system 100. All they will need to do to collect the virtual gift 108 is click the accept button, which will automatically attach or link virtual gift 108 to their one or more forms of payment 122. Further, consumers 101, 122 will not be required to carry another card in there already overstuffed wallet. Moreover, the recipient 121 can receive electronic e-mail reminders, for example, to remind recipient 121 to redeem the virtual gift 108. This would not be possible with a system that does not have the recipient's contact information, such as the existing gift card system 100.

In some embodiments, system 100 can automatically determine additional forms of payment associated with the purchaser or the recipient of the virtual gift, upon the purchaser or recipient registering one form of payment with system 100.

Each of including clients 103, 104, 123, 124, virtual gift store 109, card matching server 110, user database 112, merchant 130 and/or payment system 140 may represent any appropriate combination of hardware (e.g., servers, processors and/or memory) and/or software suitable to perform the described functions. Some embodiments of the disclosure may include logic and/or software contained within a medium. The medium may include RAM, ROM, or disk drives. The medium may be non-transitory. In some embodiments, the logic and/or software may be contained within hardware configuration. The logic and/or software may also be embedded within any other suitable medium without departing from the scope of the disclosure. Processor may represent and/or include any form of processing component, including general purpose computers, dedicated microprocessors, or other processing devices capable of processing electronic information. Examples of processor include digital signal processors (DSPs), application-specific integrated circuits (ASICs), field-programmable gate arrays (FPGAs), and any other suitable specific or general purpose processors. Memory may store processor instructions, information resources, and/or any other suitable information. Memory may comprise any collection and arrangement of volatile and/or non-volatile components suitable for storing data. For example, memory may comprise random access memory (RAM) devices, read only memory (ROM) devices, magnetic storage devices, optical storage devices, and/or any other suitable data storage devices. In particular embodiments, memory may represent, in part, computer-readable storage media on which computer instructions and/or logic are encoded.

Although not illustrated as part of the same entity or location, in some embodiments one or more functional blocks illustrated in FIG. 1 may be part of the same entity or location. For example, card matching server 110 may be associated with the same entity or location as payment system 140 or virtual gift store 109.

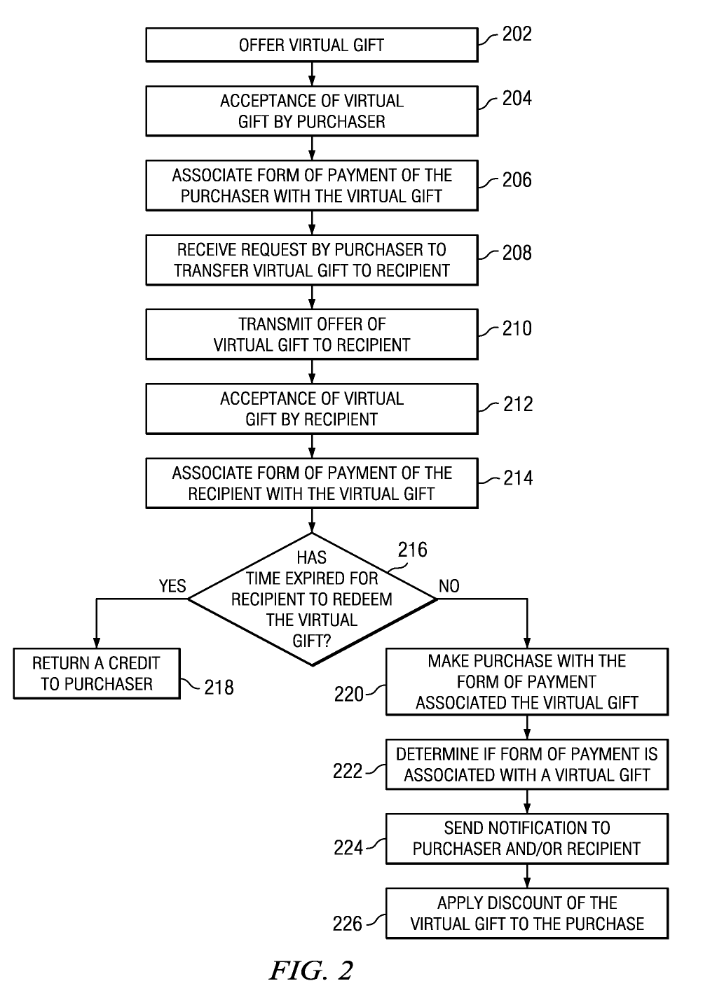

FIG. 2 is an exemplary process flow diagram 200 for purchase, transfer, and redemption of virtual gifts. In the illustrated example, flow diagram 200 begins at step 202 when a virtual gift 108 is offered to one or more purchasers 101. The means of presentment may be through a web site associated with virtual gift store 109 or merchant 130 or a social networking site (perhaps virally posted and offered by consumers 101, 121). In some embodiments, the means of presentment may occur via mass emails. The offer may be made via electronic messages to any client device.

At step 204, purchaser 101 may accept offer of virtual gift 108. In some embodiments, when the purchaser 101 opens the email with the offer or clicks on a link of a web site, purchaser 101 can register with virtual gift store 109, if purchaser 101 has not already done so. At step 206, purchaser associates a form of payment with the virtual gift 108. While registering, purchaser 101 can provide a form of payment 102 (e.g., credit or debit card number), or in other embodiments, any other payment method or vehicle useable by the purchaser 101 to purchase goods or services. Thus, the virtual gift 108 is now associated or linked to one or more forms of payment 102 in user database 112.

At step 208, system 100 may receive a request by purchaser 101 to transfer or give virtual gift 108 to recipient 121. At step 210, system 100 may transmit the offer of the already purchased virtual gift 108 to recipient 121. At step 212, recipient 121 may accept offer of the already purchased virtual gift 108. In some embodiments, when the recipient 121 opens the email with the offer or clicks on a link of a web site, recipient 121 can register with virtual gift store 109, if recipient 121 has not already done so. At step 214, recipient 121 associates a form of payment with the virtual gift 108. While registering, recipient 121 can provide a form of payment 122 (e.g., credit or debit card number), or in other embodiments, any other payment method or vehicle useable by the recipient 121 to purchase goods or services. Thus, the already purchased virtual gift 108 is now associated or linked to one or more forms of payment 102 in user database 112, without the recipient 121 having to pay anything for the already purchased virtual gift 108.

At step 212, the system may determine if the time has expired for the recipient to accept or redeem the virtual gift 108. In some embodiments, the expiration date of the virtual gift 108 may be stored in user database 112. If the time has expired, the flow diagram may continue to step 218 in which system 100 may return a credit to purchaser 101. In some embodiments, system 100 may allow purchaser to pay a discounted amount to purchase another virtual gift 108.

If the time has not expired, the flow diagram may continue to step 220, recipient 212 can redeem the virtual gift 108 by using the form of payment 122 associated with the virtual gift 108 in user database 112. The form of payment 122 may be used at a “brick and mortar” or on-line merchant 130.

At step 222, system 100 may determine if form of payment 122 is associated with goods or services of a virtual gift 108. For example, upon use of the form of payment 122, the merchant 130 may send an Authorization Request (“AR”) to the payment system 140. In such a transaction, entity logically referred to here as payment system 140 may be comprised of a credit clearing bank or acquiring bank computer system that communicates with the merchant 130, a credit card issuing computer system that manages the cardholder/consumer accounts, and a credit card association server that is associated with the particular credit card association, such as Visa® or MasterCard®. These various servers all communicate in order to clear the ARs and reconcile the cardholders' credit card statements. Once the AR has been cleared, the payment system 140, which as discussed above comprises the servers of one or more entities, may send an Approval Code (“AC”) back to the merchant 130 for the requested transaction. This transaction will also trigger the redemption of qualifying purchases for which the recipient 121 has a stored virtual gift 108, although there are be a number of possible methods by which this redemption can be accomplished.

At step 224, system may send notification to purchaser 101 and/or recipient 121 that virtual gift 108 has been redeemed to purchase goods or services at merchant 130. At step 226, system 100 applies discount of virtual gift 108 to the purchase made by recipient 121. For example, if virtual gift 108 was for 20% off purchases made at merchant 130, then this discount may be automatically applied at the point of sale terminal 132. In another example, if the virtual gift was for $15 credit to use at merchant 130, then this credit may be automatically applied to the final total of the purchase made at the point of sale terminal 132.

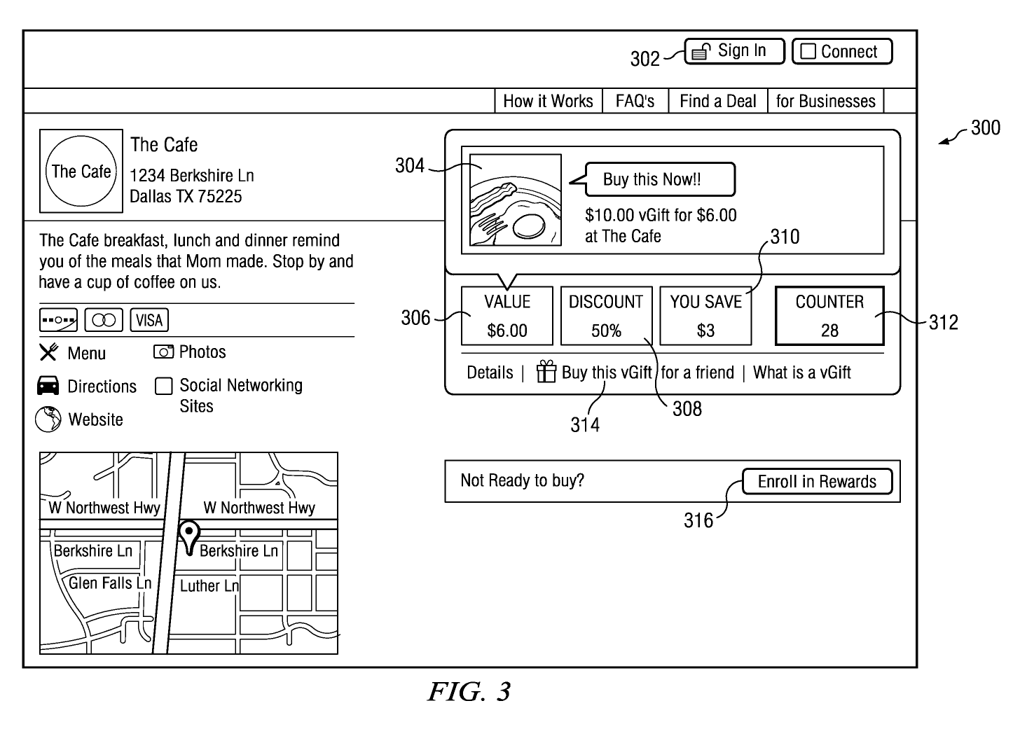

There are also a number of ways by which virtual gifts may be offered to purchaser or recipients. FIG. 3 provides an exemplary screenshot 300 of an offer of a virtual gift. This illustrated virtual gift 304 offer is for a $10 credit at the price of $6 at a merchant known as The Cafe presented on a web site. The virtual gift specifies the source of the virtual gift 304, the cost 306, the discount 308 saved by purchaser, the total savings of purchaser for buying virtual gift 310, and the counter 312 representing the number of virtual gifts that have been purchased by other consumers. Section 314 of the offer of the virtual gift also allows for purchaser to easily give this virtual gift to a recipient. Section 316 of the offer allows purchaser to easily enroll in the rewards program.

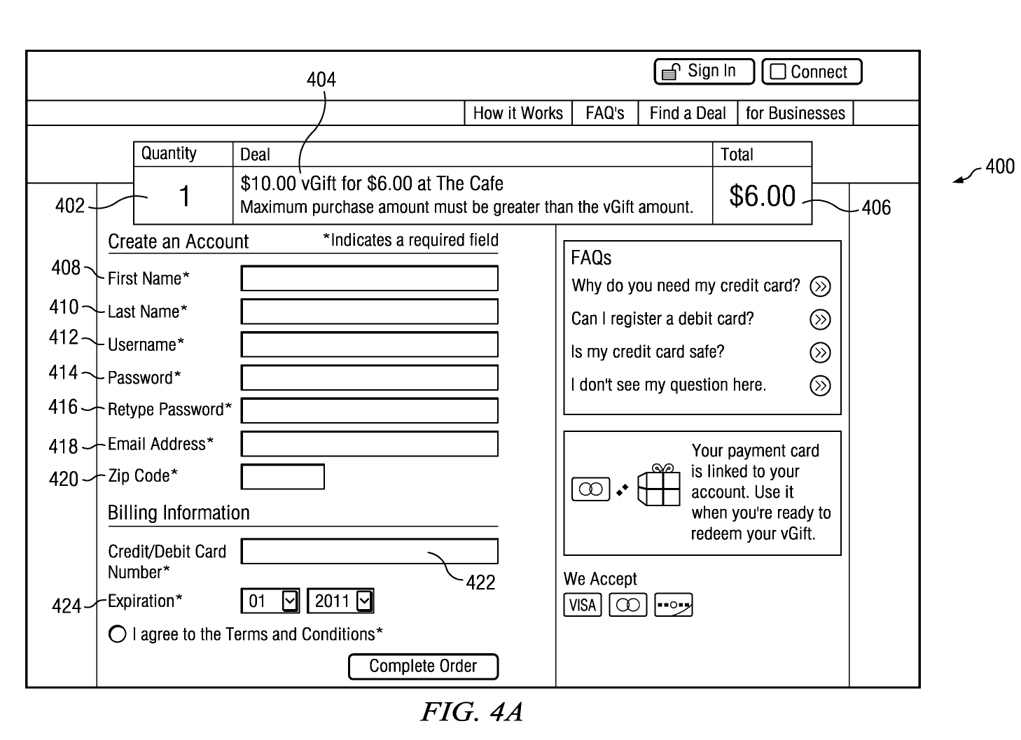

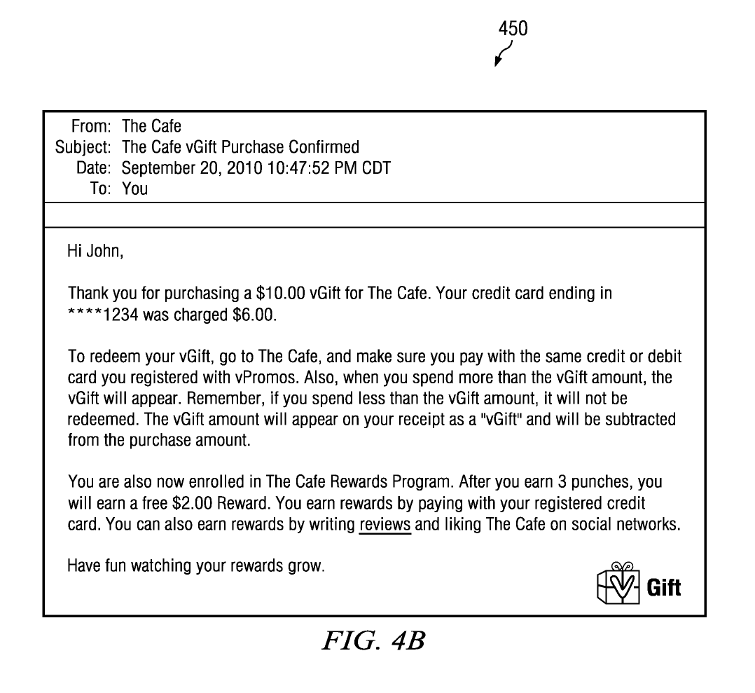

FIG. 4A is an exemplary screen shot 400 of a purchaser accepting a virtual gift. In the example shown here, fields 402, 404, and 406 illustrate the terms of the virtual gift. Fields 408, 410, 412, 414, 416, 418, and 420 allow purchaser to enter data associated with purchaser that may be stored in user database. Fields 422 and 424 allow purchaser to enter data associated with the form of payment associated with purchaser that may be stored in user database. Although not illustrated, a similar screen shot may be associated with a recipient accepting a virtual gift, except that the total amount to be charged to recipient in field 406 may be listed as $0.00 because the virtual gift will have already been purchased by purchaser.

FIG. 4B is an exemplary screen shot 450 of an acknowledgement message sent to a purchaser upon the acceptance of a virtual gift.

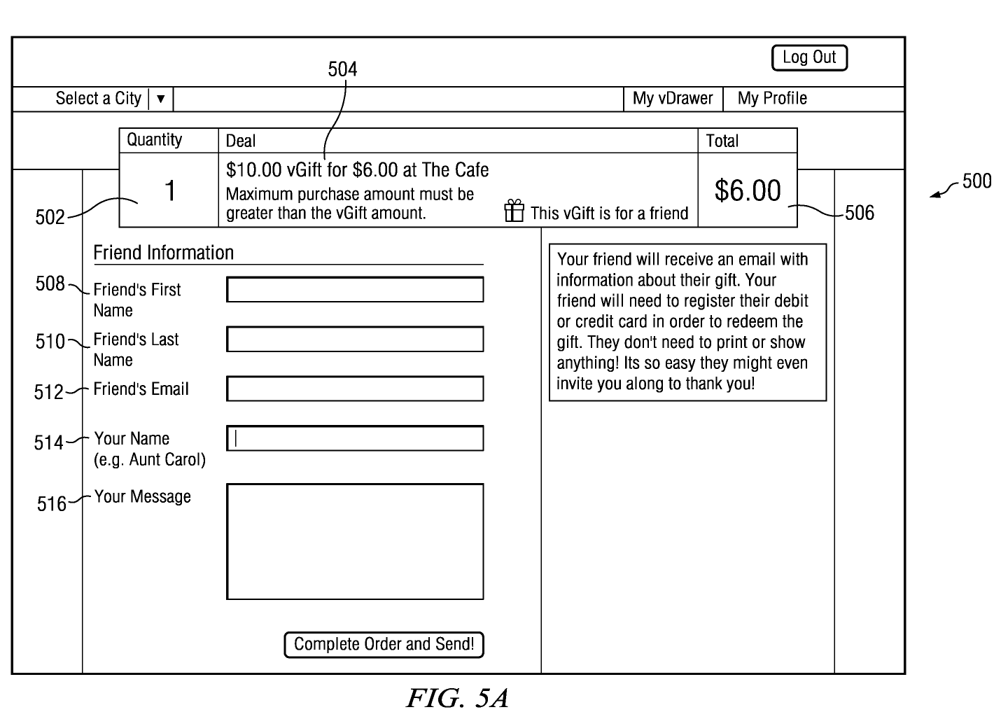

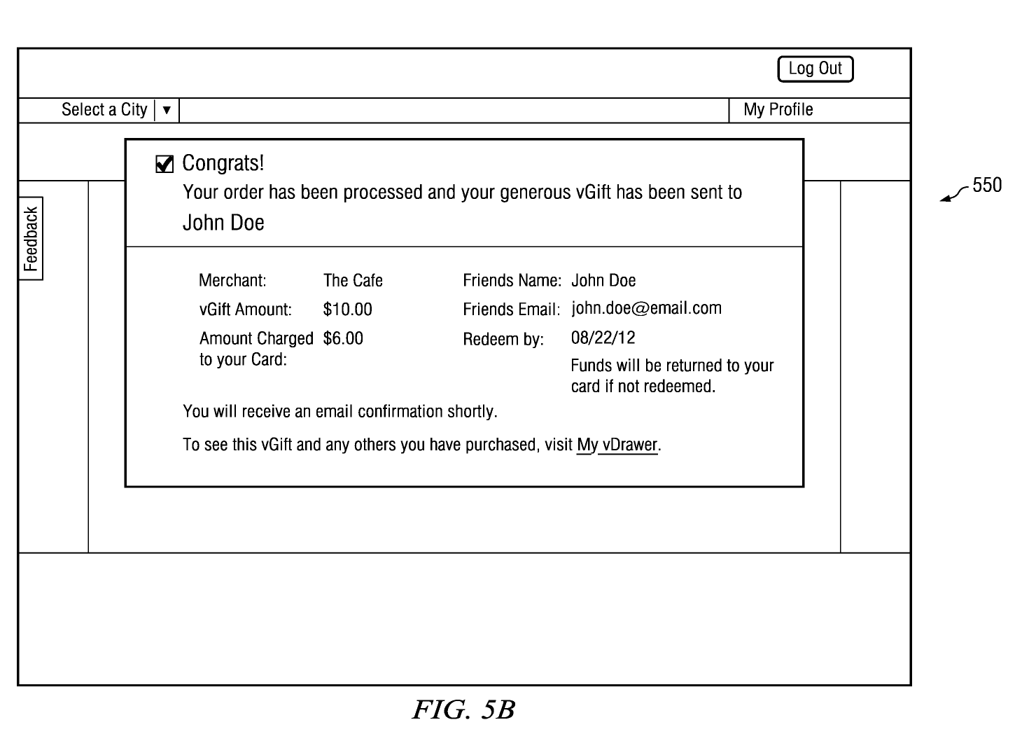

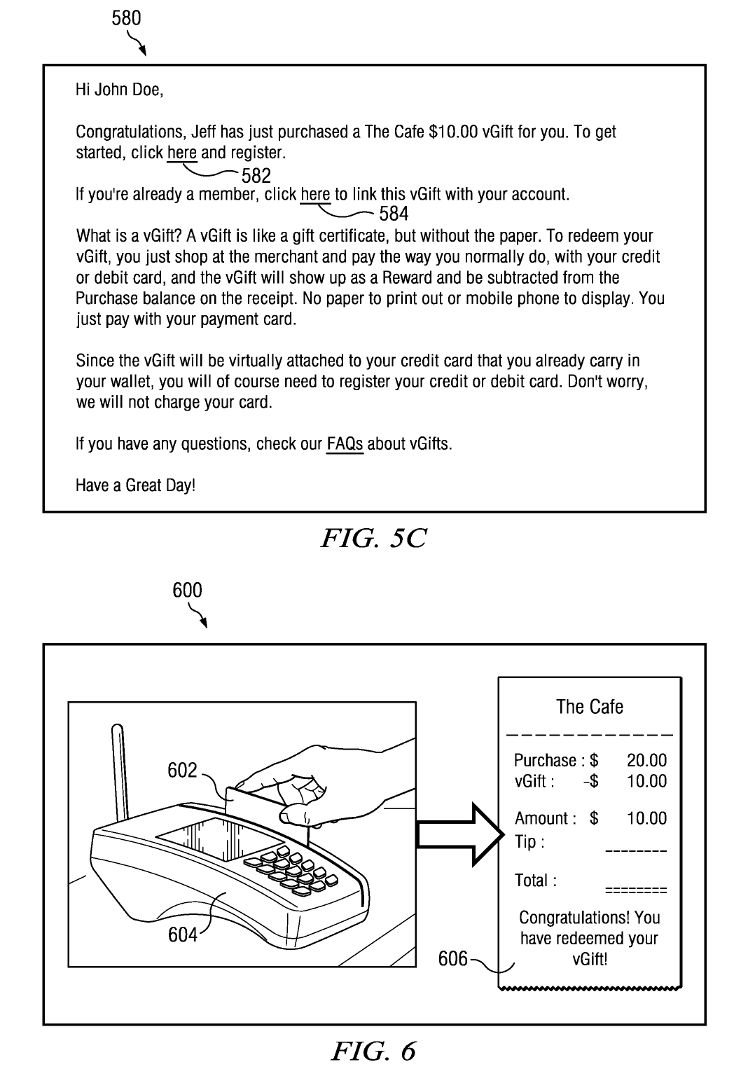

FIG. 5A is an exemplary screen shot 500 of a purchaser transferring a virtual gift to a recipient. In the example shown here, fields 502, 504, and 506 illustrate the terms of the virtual gift to be gifted to recipient 508. Fields 508, 510, and 512 allow purchaser to entry the contact details associated with recipient of virtual gift. Fields 514 and 516 allow purchaser to create a personal message to send to recipient, along with the offer of the virtual gift.

FIG. 5B is an exemplary screen shot 550 of an acknowledgement message sent to a purchaser upon the transfer of a virtual gift to a recipient.

FIG. 5C is an exemplary screen shot 580 of the offer of a virtual gift to a recipient. Link 582 allows recipient to easily be redirected to a web site to register and accept the virtual gift. Link 584 allows recipient to easily accept virtual gift simply by clicking the link, if the recipient is already a registered member with system 100.

FIG. 6 is a block diagram 600 for a recipient to use a form of payment to redeem a virtual gift. Recipient's form of payment 602 is processed by a point of sale terminal 604 at a merchant to purchase goods or services associated with virtual gift. Upon purchase, point of sale terminal will automatically apply virtual gift to the purchase as illustrated in the exemplary receipt 606 of the purchase made at the merchant known as The Cafe using the virtual gift.

The steps illustrated in FIGS. 1 and 2 may be combined, modified, or deleted where appropriate, and additional steps may also be added to those shown. Additionally, the steps may be performed in any suitable order without departing from the scope of the present disclosure.

References to credit cards in the specific embodiments above should be understood to refer broadly to other payments systems and methods such as debit cards, electronic payment systems, automated billing systems, or other payment systems, including other billing systems described in this application. “Coupons,” “coupon offers,” and “promotional offers” and “rewards” should be broadly construed to include tickets, vouchers purchased for value, and other items that are redeemable or otherwise have value, such as frequent flyer miles or other “points” or “credits” that may be redeemable for reward goods and/or services.

In all the above-described embodiments, the actual locations of the elements and the nature of the communications between different elements may be adapted depending on system design considerations. For example, depending on the relative locations of the user databases 112 and the sites receiving transaction data from the POSs, it may not be necessary to have redemption notices and coupon notices sent. Web sites associated with virtual gift store 109 may be hosted by the merchant 130, payment system 140, card matching server, or other entity.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A method of offering virtual gifts to consumers, the method comprising:
offering a virtual gift to a purchaser;
upon electronic acceptance of the virtual gift by the purchaser, establishing or maintaining an association of the accepted virtual gift with at least one form of payment associated with the purchaser;
upon a purchaser's request to transfer the virtual gift to a recipient and electronic acceptance of the virtual gift by the recipient, establishing or maintaining an association of the accepted virtual gift with at least one form of payment associated with the recipient; and
upon purchase of the subject matter of the accepted virtual gift with the form of payment associated with the recipient, electronically receiving a redemption of the accepted virtual gift.

2. The method of claim 1 wherein the establishing or maintaining further comprises establishing or maintaining a database comprising the consumer information with one or more forms of payment associated with the consumer.

3. The method of claim 1 wherein the virtual gift can be electronically accepted by the purchaser or the recipient without redeeming the accepted virtual gift.

4. The method of claim 1 and further comprising establishing a database associating the virtual gift with a payment system upon the at least one consumer's electronic first acceptance of the virtual gift.

5. The method of claim 1 wherein the acceptance the virtual gift requires that the at least one consumer associate a payment system or a form of payment with the virtual gift.

6. The method of claim 1 wherein the form of payment associated with the purchaser or the recipient is selected from the group consisting of: credit cards, debit cards, electronic payment accounts, consumer billing systems, cell-phone-based electronic payment systems, and PDA-based electronic communication systems.

7. The method of claim 1 wherein the form of offering the virtual gifts is chosen from the group consisting of: emails, banner ads, web page, social network sites, interactive television, cell phones, satellite phones, land-based phones, PDA-based wireless devices, and electronic kiosks.

8. The method of claim 1 wherein the form of transferring the virtual gifts is chosen from the group consisting of: emails, web pages, social networking sites, interactive television, cell phones, satellite phones, land-based phones, PDA-based wireless devices, and electronic kiosks.

9. The method of claim 1 wherein the method further comprises determining additional forms of payment associated with the purchaser or the recipient of the virtual gift.

10. The method of claim 1 wherein the purchase of the subject matter can occur at an entity associated with an electronic address or a physical address.

11. The method of claim 1 wherein the purchase is cleared through a payment system, and further comprising the payment system communicating with a server to determine whether the consumer has used a virtual gift to be redeemed by the purchase.

12. The method of claim 1 further comprising sending a notification to the purchaser or the recipient upon the successful redemption of the virtual gift.

13. The method of claim 1 further comprising sending a notification to a web page associated with an account of the purchaser upon the successful redemption of the virtual gift.

14. The method of claim 1 wherein the virtual gift is redeemed upon the recipient using the form of payment with a point of sale device.

15. The method of claim 1 wherein the form of payment is an electronic form of payment.

16. The method of claim 1 wherein the virtual gift is not tangible.

17. The method of claim 1 further comprising associating the form of payment of the purchaser or the recipient with a rewards system, wherein the rewards system provides incentives to use the form of payment at one or more merchant sites.

18. The method of claim 1 further comprising upon the acceptance of a virtual gift by the purchaser, automatically associating the one or more forms of payment of the purchaser to the virtual gift based on information previously stored.

19. The method of claim 1 further comprising determining if the recipient has accepted or redeemed the virtual gift within a particular time period and return a credit amount to the purchaser in the event that the recipient does not accept or redeem the virtual gift within the particular time period.

20. A system for offering virtual gifts to consumers, the system comprising:
one or more computer-servers comprising one or more computing devices, wherein the one or more computer-servers are operable to:
offer a virtual gift to a purchaser;
establish or maintain an association of the accepted virtual gift with at least one form of payment associated with the purchaser, upon electronic acceptance of the virtual gift by the purchaser;
establish or maintain an association of the accepted virtual gift with at least one form of payment associated with the recipient, upon a purchaser's request to transfer the virtual gift to a recipient and electronic acceptance of the virtual gift by the recipient; and
electronically receive a redemption of the accepted virtual gift, upon purchase of the subject matter of the accepted virtual gift with the form of payment associated with the recipient.

21. The system of claim 20 wherein the establishing or maintaining further comprises establishing or maintaining a database comprising the consumer information with one or more forms of payment associated with the consumer.

22. The system of claim 20 wherein the virtual gift can be electronically accepted by the purchaser or the recipient without redeeming the accepted virtual gift.

23. The system of claim 20 and further comprising establishing a database associating the virtual gift with a payment system upon the at least one consumer's electronic first acceptance of the virtual gift.

24. The system of claim 20 wherein the acceptance of the virtual gift requires that the at least one consumer associate a payment system or a form of payment with the virtual gift.

25. The system of claim 20 wherein the form of payment associated with the purchaser or the recipient is selected from the group consisting of: credit cards, debit cards, electronic payment accounts, consumer billing systems, cell-phone-based electronic payment systems, and PDA-based electronic communication systems.

26. The system of claim 20 wherein the form of offering the virtual gifts is chosen from the group consisting of: emails, banner ads, web page, social network sites, interactive television, cell phones, satellite phones, land-based phones, PDA-based wireless devices, and electronic kiosks.

27. The system of claim 20 wherein the form of transferring the virtual gifts is chosen from the group consisting of: emails, web pages, social networking sites, interactive television, cell phones, satellite phones, land-based phones, PDA-based wireless devices, and electronic kiosks.

28. The system of claim 20 wherein the one or more computer-servers are further operable to determine additional forms of payment associated with the purchaser or the recipient of the virtual gift.

29. The system of claim 20 wherein the purchase of the subject matter can occur at an entity associated with an electronic address or a physical address.

30. The system of claim 20 wherein the purchase is cleared through a payment system, and further comprising the payment system communicating with a server to determine whether the consumer has used a virtual gift to be redeemed by the purchase.

31. The system of claim 20 the one or more computer-servers are operable to send a notification to the purchaser or the recipient of the successful redemption of the virtual gift.

32. The system of claim 20 wherein the one or more computer-servers are further operable to send a notification to a web page associated with an account of the purchaser upon the successful redemption of the virtual gift.

33. The system of claim 20 wherein the virtual gift is redeemed upon the recipient using the form of payment with a point of sale device.

34. The system of claim 20 wherein the form of payment is an electronic form of payment.

35. The system of claim 20 wherein the virtual gift is not tangible.

36. The system of claim 20 wherein the one or more computer-servers are further operable to associate the form of payment of the purchaser or the recipient with a rewards system, wherein the rewards system provides incentives to use the form of payment at one or more merchant sites.

37. The system of claim 20 wherein the one or more computer-servers are further operable to automatically associate the one or more forms of payment of the purchaser to the virtual gift based on information previously stored, upon the acceptance of a virtual gift by the purchaser.

38. The system of claim 20 wherein the one or more computer-servers are further operable to determine if the recipient has accepted or redeemed the virtual gift within a particular time period and return a credit amount to the purchaser in the event that the recipient does not accept or redeem the virtual gift within the particular time period.
